(19) United States
(12) Patent Application Publication
(10) Pub. No.: US 2010/0312377 A1
(43) Pub. Date: Dec. 9, 2010

(54) CHANGE REFILL AND MANAGEMENT SYSTEM

(76) Inventors: Tsutomu Iwata, Kanagawa-ken (JP); Kazuyuki Shimizu, Saitama-Ken (JP); Koichi Nishida, Hyogo-Ken (JP)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/735,756

(22) PCT Filed: Jan. 30, 2009
(86) PCT No.: PCT/JP2009/051574

§ 371 Date: Aug. 13, 2010

(30) Foreign Application Priority Data
Feb. 14, 2008 (JP) 2008-33501

(51) Int. Cl. G06F 7/00; G07D 9/00; G07G 1/00; G07G 1/12

(52) U.S. Cl. 700/219; 453/58

(57) ABSTRACT

This invention provides a change refill and management system, which can substantially reduce the initial cost for a coin-roll management apparatus, even in the case in which a plurality of register units are provided in the system. The change refill and management system related to this invention includes: a coin-roll management apparatus (20) capable of storing therein coin rolls of a plurality of denominations; and a plurality of register units (10), each register unit (10) including at least a change machine (14) or drawer, more than one register unit (10) being provided to the one coin-roll management apparatus (20) in the vicinity of this coin-roll management apparatus (20). The coin-roll management apparatus (20) includes a coin-roll-total-amount detection unit (22a) for detecting the total amount of money of the coin rolls stored in each coin-roll drawer (23, 24, 25) provided to this coin-roll management apparatus (20). Each of the register units (10) includes a coin-refill-information detection unit (14c) for detecting refill information on the coins refilled to the change machine (14) or drawer of this register unit (10). Further, each of the register units (10) is connected, for communication, with the coin-roll management apparatus (20).

### FIELD OF THE INVENTION

The present invention relates to a change refill and management system including a coin-roll management apparatus capable of storing therein coin rolls of a plurality of denominations, and a plurality of register units, more than one register unit being provided to the one coin-roll management apparatus in the vicinity of this coin-roll management apparatus. In particular, this invention relates to the change refill and management system that can substantially reduce the initial cost required for the coin-roll management apparatus, even in the case the plurality of register units are provided.

### BACKGROUND OF THE INVENTION

In the past, the change refill and management system, which includes the coin-roll management apparatus capable of storing therein the coin rolls (i.e., packages each prepared by collecting and wrapping a predetermined number of coins of the same denomination into a bar-like shape) of the plurality of denominations, and the register unit provided in the vicinity of the coin-roll management apparatus and connected, for communication, with this coin-roll management apparatus, has been known (e.g., see JP2006-85332A). The coin-roll management apparatus includes: for example, a casing (or storage body); a coin-roll drawer provided to be optionally drawn out relative to the casing and having a plurality of coin-roll storage units, each capable of storing therein one coin roll; and a coin-roll-total-amount detection unit adapted for detecting the total amount of money of the coin-rolls stored in the coin-roll drawer. Meanwhile, the register unit includes, for example, a register, a drawer and a coin change machine.

In the conventional change refill and management system as disclosed in the above JP2006-85332A, one register unit is provided so as to correspond with one coin-roll management apparatus, and this coin-roll management apparatus is connected, for communication, with the corresponding register unit, one by one (see FIG. 1 of JP2006-85332A).

### DISCLOSURE OF THE INVENTION

However, in such a conventional change refill and management system as disclosed in the above JP2006-85332A, since the coin-roll management apparatus is connected, for communication, with the corresponding register unit, one by one, the coin-roll management apparatus has to be installed for each register unit. Thus, for providing the plurality of register units, it is necessary to provide the coin-roll management apparatuses, in the same number as the number of the register units, leading to undue increase of the initial cost required for such coin-roll management apparatuses. Further, in the case such a plurality of register units is provided, each register unit is refilled with the coins for the change from each corresponding coin-roll management apparatus. Therefore, in order to avoid inadvertent shortage of the change in any of the register units, it is necessary for each coin-roll management apparatus to store therein some excessive amount of the coin rolls. Thus, the total amount of such coin rolls respectively stored in the plurality of coin-roll management apparatuses may tend to be unduly large.

The present invention was made in light of the above problem. It is an object of this invention to provide a change refill and management system, which can substantially reduce the initial cost for the coin-roll management apparatus, even in the case the plurality of register units are provided, and which can reduce the total amount of the coin-rolls stored in the coin-roll management apparatus, as compared with the case in which the coin-roll management apparatuses are provided with the register units, one by one, and which can prevent negative influence that may be caused by lack of balance of the denominations of the change dispensed, even in the case the change of a certain denomination or denominations is dispensed, in a considerably great amount, from some register units among the plurality of register units.

The change refill and management system of this invention includes: a coin-roll management apparatus capable of storing therein coin rolls of a plurality of denominations; and a plurality of register units, each register unit including at least a change machine or drawer, more than one register unit being provided to the one coin-roll management apparatus in the vicinity of the coin-roll management apparatus, the coin-roll management apparatus includes a storage body, a coin-roll drawer provided to be optionally drawn out from the storage body and having a plurality of coin-roll storage units, each coin-roll storage unit being capable of storing therein one coin roll, and a coin-roll-total-amount detection unit for detecting the total amount of money of one or more coin rolls stored in the coin-roll drawer, each of the register units includes a coin-refill-information detection unit for detecting refill information on the coins refilled to the change machine or drawer of the register unit, and each of the register units is connected, for communication, with the coin-roll management apparatus.

According to this change refill and management system, the number of the coin-roll management apparatuses provided to the plurality of register units can be substantially lessened relative to the number of the register units (e.g., the number of such coin-roll management apparatuses can be set at one). Therefore, even in the case the plurality of register units are provided, there is no need for providing the same number of coin-roll management apparatuses, thereby significantly reducing the initial cost required for the coin-roll management apparatus. Further, since the coins for the change can be refilled to the plurality of register units from the one coin-roll management apparatus, the total amount of the coin rolls stored in such a coin-roll management apparatus can be substantially reduced, as compared with the case in which the coin-roll management apparatuses are provided with the register units, one by one. Moreover, since the one coin-roll management apparatus can be commonly used for the plurality of register units, the negative effects that may be caused by the lack of balance of the denominations of the change can be prevented, even in the case the change of the certain denomination is dispensed, in a considerably large amount, from some register units among the plurality of register units.

In the change refill and management system according to the present invention, it is preferable that a control unit is provided to at least one of the coin-roll management apparatus and each register unit, the control unit serves to receive information concerning the total amount of money of the one or more coin rolls detected by the coin-roll-total-amount detection unit and the refill information on the coins detected by the coin-refill-information detection unit, and the control unit compares the information concerning total amount of money of the one or more coin rolls in the coin-roll management apparatus with the refill information on the coins refilled to the change machine or drawer of each register unit.

In the change refill and management system described above, it is preferable that the control unit compares a decreased amount of money of the one or more coin rolls decreased in the coin-roll management apparatus with the amount of money of the coins refilled to the change machine or drawer of each of the register units, and if both of the amounts of money are the same relative to each other, the control unit judges that the refill of the coins to each of the register units from the coin-roll management apparatus has been carried out without any problem. Alternatively, it is preferable that the control unit compares a decreased amount of money of the one or more coin rolls decreased in the coin-roll management apparatus with the amount of money of the coins refilled to the change machine or drawer of each of the register units, the coin refill and management system further includes an alerting unit, and when both of the amounts of money are not coincident with each other, the alerting unit alerts a user that both of the amounts of money are not coincident with each other.

In the change refill and management system described above, it is preferable that each of the register units is directly connected, for communication, with the coin-roll management apparatus. Alternatively, it is preferable that the register units are connected, for communication, with one another, and the coin-roll management apparatus is connected, for communication, with at least one of the register units.

In the change refill and management system described above, it is preferable that the plurality of coin-roll management apparatuses are provided, and each of the register units is connected, for communication, with the plurality of coin-roll management apparatuses.

In the change refill and management system of the present invention, it is preferable that the coin refill and management system further includes a POS system unit connected, for communication, with the coin-roll management apparatus, and connected, for communication, with each of the register units, the POS system unit including a control unit, the control unit serves to receive information concerning the total amount of money of the one or more coin rolls detected by the coin-roll-total-amount detection unit and the refill information on the coins detected by the coin-refill-information detection unit, and the control unit compares the information concerning the total amount of money of the one or more coin rolls in the coin-roll management apparatus with the refill information on the coins refilled to the change machine or drawer of each of the register units.

In the change refill and management system described above, it is preferable that the control unit compares a decreased amount of money of the one or more coin rolls decreased in the coin-roll management apparatus with the amount of money of the coins refilled to the change machine or drawer of each of the register units, and if both of the amounts of money are the same relative to each other, this control unit judges that the refill of the coins to each of the register units from the coin-roll management apparatus has been carried out without any problem. Alternatively, it is preferable that the control unit compares a decreased amount of money of the one or more coin rolls decreased in the coin-roll management apparatus with the amount of money of the coins refilled to the change machine or drawer of each of the register units, and the coin refill and management system further includes an alerting unit, and when both of the amounts of money are not coincident with each other, the alerting unit alerts a user that both of the amounts of money are not coincident with each other.

In the change refill and management system described above, it is preferable that while the refill of the coins to one register unit among the plurality of register units from the coin-roll management apparatus is performed, the control unit provided to at least one of the coin-roll management apparatus, each register unit and the POS system unit rejects receiving any signal sent from the other register units.

It is further preferable that once the coin-roll-total-amount detection unit detects that the one or more coin rolls to be refilled to the one register unit have been taken out from the coin-roll drawer in the coin-roll management apparatus, the control unit is capable of receiving a signal sent from the other register units. It is also preferable that if the one or more coin rolls to be refilled to the one register unit are not taken out from the coin-roll drawer within a predetermined period of time, when the refill of the coins to the one register unit among the plurality of register units from the coin-roll management apparatus has to be performed, the control unit cancels the refill of the coins to the one register unit from the coin-roll management apparatus.

Alternatively, in the change refill and management system described above, it is preferable that the control unit provided to at least one of the coin-roll management apparatus, each register unit and the POS system unit conducts monitoring of each refill of the coins to the plurality of register units from the coin-roll management apparatus.

### BRIEF DESCRIPTION OF THE DRAWINGS

FIG. 1 is a schematic diagram showing one construction of the change refill and management system of this invention.

FIG. 2 is a schematic diagram showing another construction of the change refill and management system of this invention.

FIG. 3 is a schematic diagram showing still another construction of the change refill and management system of this invention.

FIG. 4 is a schematic diagram showing still another construction of the change refill and management system of this invention.

FIG. 5 is a schematic diagram showing yet still another construction of the change refill and management system of this invention.

FIG. 6 is a diagram showing details of the construction of each register unit in the change refill and management system shown in any one of FIGS. 1 through 5.

FIG. 7 is a diagram showing details of the construction of the coin-roll management apparatus in the change refill and management system shown in any one of FIGS. 1 through 5.

FIG. 8 is a perspective view of the coin-roll management apparatus in the change refill and management system shown in any one of FIGS. 1 through 5.

FIG. 9(a) is a perspective view of an upper portion of the coin-roll management apparatus shown in FIG. 8, illustrating an internal structure of this coin-roll management apparatus, and FIG. 9(b) is a perspective view of a lower portion of the coin-roll management apparatus shown in FIG. 8, also illustrating the internal structure of this coin-roll management apparatus.

FIG. 10 is a diagram showing typical output signals of an encoder and sensors in the coin-roll management apparatus shown in FIG. 9.

FIG. 11 is a flow chart showing the operation of the change refill and management system shown in FIG. 1.

FIG. 12 is a schematic diagram showing still another construction of the change refill and management system of this invention.

### DETAILED DESCRIPTION OF THE INVENTION

Hereinafter, one embodiment of the present invention will be described with reference to the drawings. FIGS. 1 through 11 respectively show the embodiment of the change refill and management system related to this invention.

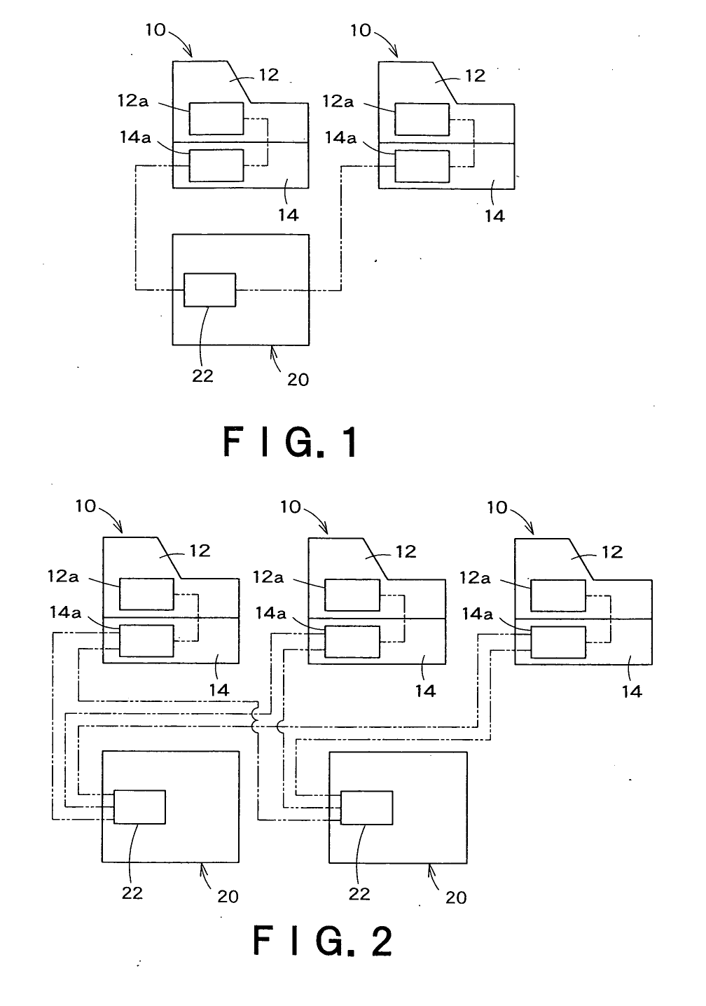

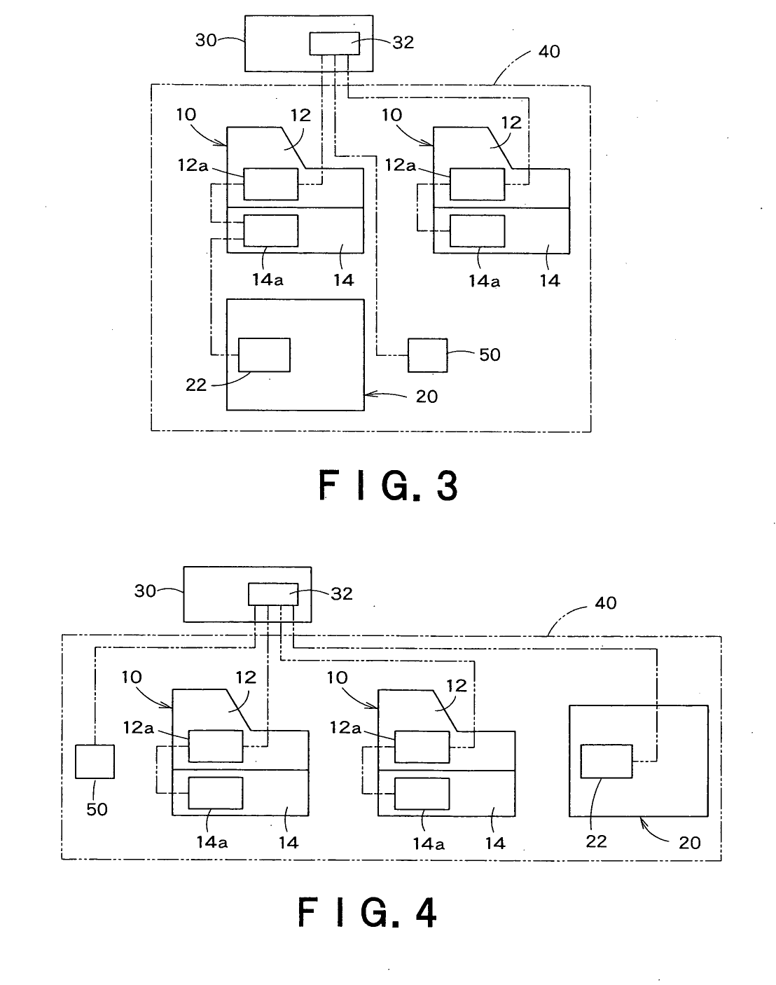

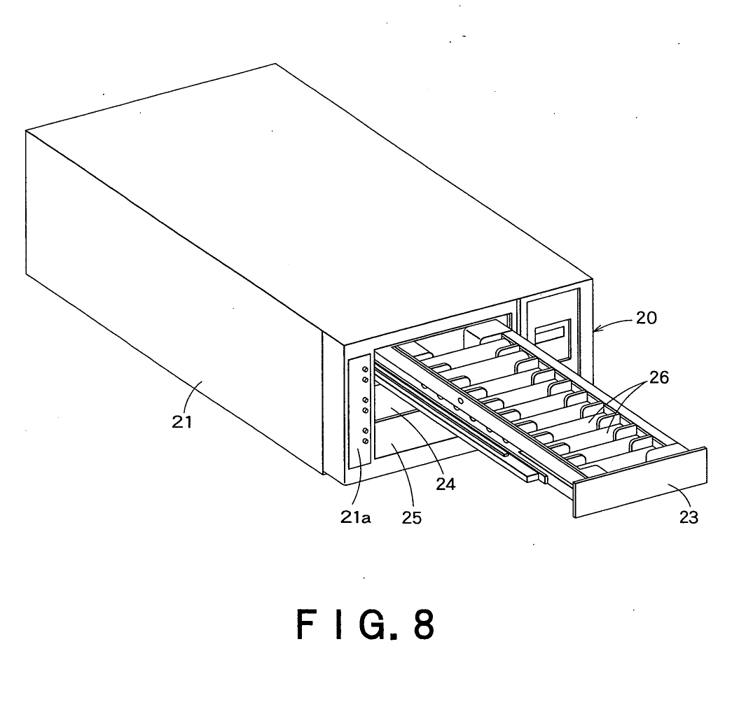

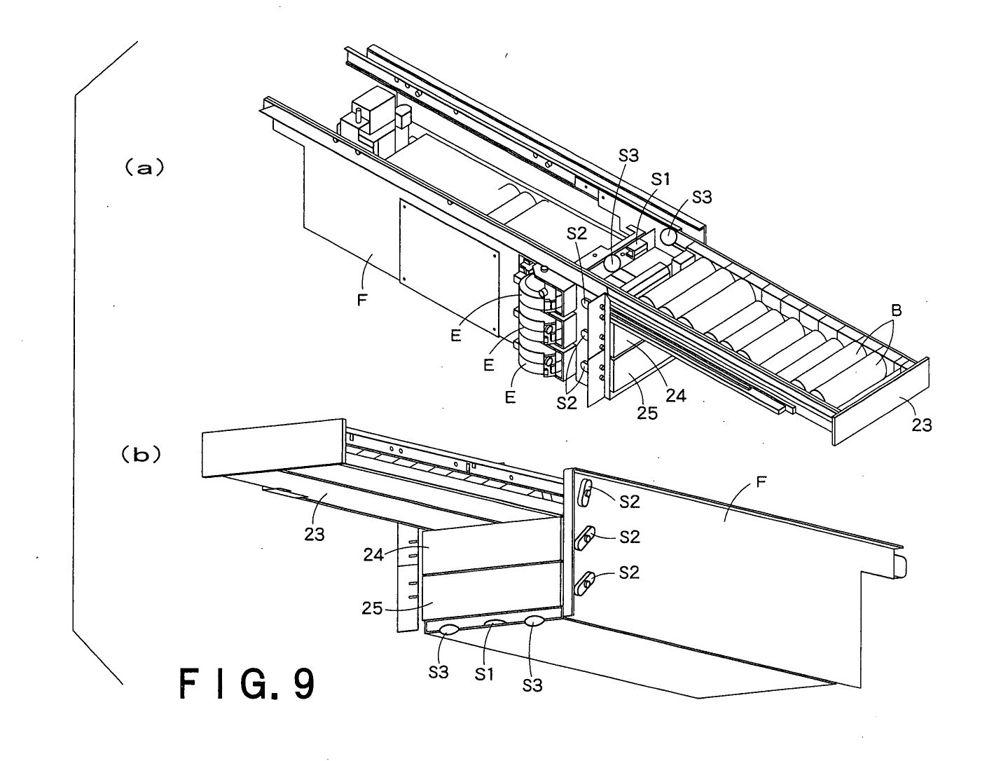

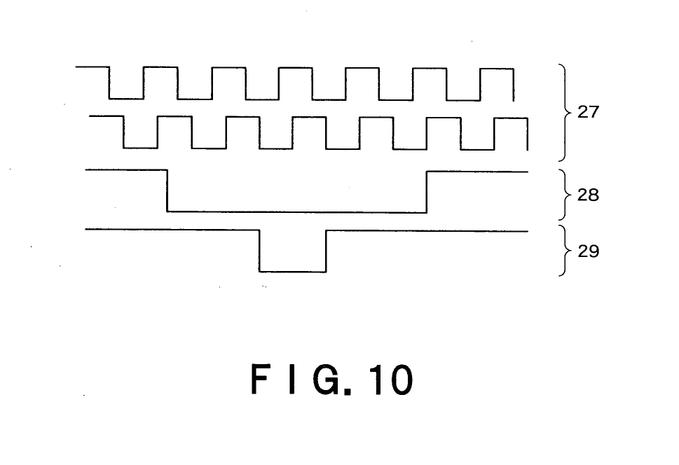

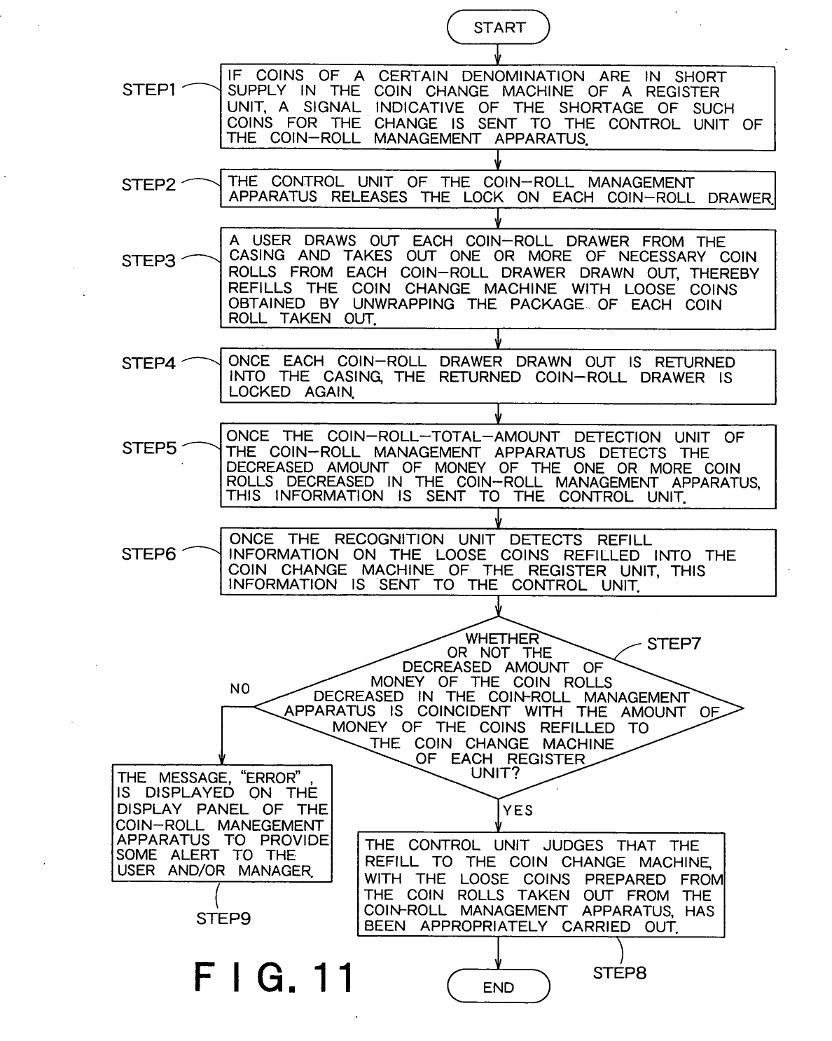

Among these drawings, FIG. 1 is the schematic diagram showing the construction of the change refill and management system of the embodiment of this invention, and FIG. 2 is the schematic diagram showing another construction of the change refill and management system of the embodiment of this invention. Further, FIGS. 3 to 5 and FIG. 12 are the schematic diagrams respectively showing still other constructions of the change refill and management system of the embodiment of this invention. FIG. 6 is the diagram showing details of the construction of each register unit in the change refill and management system shown in any one of FIGS. 1 through 5, and FIG. 7 is the diagram showing details of the construction of the coin-roll management apparatus in the change refill and management system shown in any one of FIGS. 1 through 5. In addition, FIG. 8 is the perspective view of the coin-roll management apparatus shown in FIG. 7, and FIG. 9(a) is the perspective view of the upper portion of the coin-roll management apparatus shown in FIG. 8, illustrating the internal construction of this coin-roll management apparatus, and FIG. 9(b) is the perspective view of the lower portion of the coin-roll management apparatus shown in FIG. 8, also illustrating the internal construction of this coin-roll management apparatus. Further, FIG. 10 is the diagram showing the typical output signals of the encoder and sensors in the coin-roll management apparatus shown in FIG. 9, and FIG. 11 is the flow chart showing the operation of the change refill and management system shown in FIG. 1.

As shown in FIG. 1, the change refill and management system of this embodiment includes a coin-roll management apparatus 20 capable of storing therein the coin rolls of the plurality of denominations, and register units 10 respectively provided in the vicinity of the coin-roll management apparatus 20. As shown in FIG. 1, in this change refill and management system, two register units 10 are provided to the one coin-roll management apparatus 20, and this coin-roll management apparatus 20 is connected, for communication, with each of the two register units 10.

Now, referring to FIGS. 6 through 10, the details of the construction of each of the registers 10 and coin-roll management apparatus 20 will be discussed.

First, the construction of each register unit 10 will be described, with reference to FIGS. 1 and 6.

As shown in FIGS. 1 and 6, each register unit 10 includes a cash register 12 and a coin change machine 14. The cash register 12 has a control unit 12a adapted for controlling this cash register 12. Meanwhile, the coin change machine 14 has another control unit 14a adapted for controlling this coin change machine 14. The control unit 12a of the cash register 12 and the control unit 14a of the coin change machine 14 are connected with each other for communication by, for example, a communication cable or the like.

Each cash register 12 is operated by a clerk, when a customer pays money to the clerk in a store. Usually, this cash register 12 is composed of, for example, an electronic cash register (ECR) or the like. Namely, once the customer pays the money to the clerk to buy goods, the clerk inputs, by hand, the amount of the money paid from the customer, to the cash register 12.

Each coin-roll change machine 14, as shown in FIG. 6, includes an inlet 14b for the coins (or loose coins), a coin recognition unit 14c, a coin denomination sorting unit 14d, a storage unit 14e for each denomination of the coins, and a coin disbursing slot 14f. More specifically, the loose coins respectively fed into the casing of each coin change machine 14 through the inlet 14b thereof are first recognized, regarding the denomination and number thereof, by the recognition unit 14c. Then, such loose coins recognized by the recognition unite 14c are sorted, by denomination, by the sorting unit 14d. Thereafter, the storage unit 14e stores therein the loose coins sorted by the sorting unit 14d, by denomination.

Further, each coin change machine 14 is configured to disburse the loose coins stored in the storage unit 14e by denomination, into the disbursing slot 14f, corresponding to each demand on the disbursement of the change or the like. It is noted that the loose coins deposited in the inlet 14b of the coin change machine 14 include the coins paid from the customer, and the coins for the change prepared by unwrapping the package of each coin roll taken out from the coin-roll management apparatus 20 as will be described later.

In each coin change machine 14, the recognition unit 14c is connected, for communication, with the control unit 14a. With this configuration, the refill information on the coins refilled to the coin change machine 14, detected by the recognition unit 14c, is transmitted to the control unit 14a. Namely, each recognition unit 14c can serve as the coin-refill-information detection unit adapted for detecting the refill information concerning the coins refilled to the coin change machine 14. However, it is noted that the coin-refill-information detection unit is not limited to such a recognition unit 14c as described above that can automatically recognize each coin. For instance, this coin-refill-information detection unit may be provided in such an aspect that the user inputs, by hand, the amount of money of the coins for the change refilled to the coin change machine 14, to the cash register 12, and then this information is sent to the control unit 14a from the control unit 12a, whereby the refill information on the coins can be detected by the control unit 14a.

Now, the construction of the coin-roll management apparatus 20 will be described with reference to FIG. 1 and FIGS. 7 through 10. As shown in FIGS. 1 and 7, the coin-roll management apparatus 20 includes a casing (storage body) 21, three coin-roll drawers 23, 24, 25, each provided to be optionally drawn out forward relative to the casing 21, and the coin-roll-total-amount detection unit 22a adapted for detecting the total amount of money of the coin-rolls stored in each coin-roll drawer 23, 24, 25. In each coin-roll drawer 23, 24, 25, a plurality of coin-roll storage units 26 are provided to store therein one coin roll respectively, such that the coin rolls stored in these storage units 26 can include at least one coin roll for each denomination (see FIG. 8). Further, in the coin-roll management apparatus 20, a control unit 22 adapted for controlling this coin-roll management apparatus 20 is provided. As shown in FIG. 7, the control unit 22 is connected, for communication, with the coin-roll-total-amount detection unit 22a.

Further, referring to FIGS. 8 through 10, the construction of the coin-roll management apparatus 20 will be described more specifically. For instance, the upper stage coin-roll drawer 23 includes eight storage units 26 provided for 1-yen coin rolls and two storage units 26 provided for 5-yen coin rolls. The middle stage coin-roll drawer 24 includes eight storage units 26 provided for 10-yen coin rolls and two storage units 26 provided for 50-yen coin rolls. The lower stage coin-roll drawer 25 includes eight storage units 26 provided for 100-yen coin rolls, and two storage units 26 provided for 500-yen coin rolls. In each coin-roll storage unit 26, one coin roll is stored, laterally and horizontally, with the axis of this coin roll oriented orthogonally to the direction in which each coin-roll drawer 23, 24, 25 is drawn out. During a normal operation, each coin-roll drawer 23, 24, 25 of the coin-roll management apparatus 20 is locked in the casing 21, and thus such a coin-roll drawer 23, 24 or 25 cannot be usually drawn out from the casing 21. Only when a signal for releasing such a locked state (i.e., an unlocking signal) is sent from the control unit 22, each coin-roll drawer 23, 24, 25 can be drawn out from the casing 21.

The coin-roll-total-amount detection unit 22a can detect the existence of the coin rolls, for each coin-roll storage unit 26 of each coin-roll drawer 23, 24, 25. Further, this coin-roll-total-amount detection unit 22a can sent information concerning the total amount of money of the so-detected coin rolls to the control unit 22. In addition, a display panel 21a, adapted for displaying a status, such as FULL/EMPTY, of the coin rolls of each denomination, based on each detection result obtained by the coin-roll-total-amount detection unit 22a, is provided to a front face of the casing 21 of the coin-roll management apparatus 20.

Now, referring to FIGS. 9(a) and 9(b), more specific construction of the coin-roll-total-amount detection unit 22a will be discussed. FIGS. 9(a) and 9(b) respectively show a frame F provided in the casing 21 of the coin-roll management apparatus 20. This frame F can serve to hold each coin-roll drawer 23, 24, 25, such that each coin-roll drawer 23, 24 or 25 can slide in both of forward and backward directions. To a front portion of the frame F, a pair of upper and lower coin-roll diameter sensors S1 (or light emission/light receiving units), three pairs of left and right coin-roll perforation sensors (or light emission/light receiving units) S2, and two pairs of upper and lower coin-roll width sensors (or light emission/light receiving units) S3 are provided, respectively. Further, to the left side face of the frame F adjacent to the front portion thereof, a total of three two-phase encoders E are provided, respectively corresponding to the coin-roll drawers 23, 24, 25.

When each coin-drawer 23, 24, 25 that has been drawn out from the frame F is pushed, by hand, into the frame F, or when this coin-drawer 23, 24 or 25 that has been stored in the frame F is drawn out, by hand, therefrom, each corresponding two-phase encoder E, the coin-roll diameter sensors S1 and coin-roll perforation sensors S2 output the signals 27, 28, 29, respectively, as shown in FIG. 10. More specifically, based on the signal 27 outputted from each two-phase encoder E, among the above output signals, the displacement in the push-in direction of each corresponding coin-roll drawer 23, 24, 25, relative to the respective sensors S1, S2, can be identified. Meanwhile, based on the signals 28, 29 of the respective sensors S1, S2, the change between transmitted light/blocked light, due to the outer periphery and inner periphery (i.e., in the case of 5-yen and 50-yen coin rolls, each having a central perforation) of each coin roll B (see FIG. 9(a)), can be identified.

With this configuration, not only the existence of each coin roll itself but also the diameter and existence of the central perforation of each stored coin roll can be detected, for each coin-roll storage unit 26 of the corresponding coin-roll drawers 23, 24, 25. Namely, this configuration can also detect whether or not each coin roll, stored in each coin-roll storage unit 26, is the coin roll of the denomination to be duly stored therein. Further, by utilizing the aforementioned coin-roll width sensors S3, the width (or length in the axial direction) of each coin roll can also be detected for each coin-roll storage unit 26. Usually, however, the denomination of each coin roll can be identified sufficiently, simply by determining the diameter of the coin roll as well as by detecting the existence of the central perforation thereof. Therefore, it may be an option to provide the coin-roll width sensors S3.

As described above, the coin-roll-total-amount detection unit 22a is composed of the three two-phase encoders E, pair of upper and lower coin-roll diameter sensors (or light emission/light receiving units) S1, three pairs of left and right coin-roll perforation sensors (or light emission/light receiving units) S2, and two pairs of upper and lower coin-roll width sensors (or light emission/light receiving units) S3. It is noted that the coin-roll-total-amount detection unit 22a is not limited to this aspect, but may be configured in other various aspects, provided that such configurations can allow the total amount of money of the coin rolls respectively stored in each coin-roll drawer 23, 24, 25 to be adequately detected.

As shown in FIG. 1, the control unit 14a provided to the coin change machine 14 of each register unit 10 and the control unit 22 provided to the coin-roll management apparatus 20 are connected with each other, for communication, through a cable or the like, or otherwise by wireless communication. In this case, the information on the total amount of money of the coin rolls detected by the coin-roll-total-amount detection unit 22a of the coin-roll management apparatus 20 and the refill information on the coins detected by the recognition unit 14c of each coin change machine 14 are respectively sent to any one of the control unit 12a of each cash register 12, the control unit 14a of each coin change machine 14a and the control unit 22 of the coin-roll management apparatus 20. Hereinafter, the case in which such information is sent to the control unit 22 of the coin-roll management apparatus 20 will be described. Of course, in place of the control unit 22, the control unit 12a and/or 14a may receive such information and perform the control operation, as will be described below.

Namely, once the information concerning the total amount of money of the coin rolls detected by the coin-roll-total-amount detection unit 22a of the coin-roll management apparatus 20 and the refill information on the coins detected by the recognition unit 14c of each coin change machine 14 are respectively sent to the control unit 22, this control unit 22 first compares the information concerning the total amount of money of the one or more coin rolls in the coin-roll management apparatus 20 with the refill information on the coins refilled to the coin change machine 14 of each register unit 10.

More specifically, the control unit 22 compares a decreased amount of money of the one or more coin rolls decreased in the coin-roll management apparatus 20 with the amount of money of the coins refilled to the coin change machine 14 of each register unit 10. Then, if both of the amounts of money are the same relative to each other, the control unit 22 judges that the refill of the coins to each register unit 10 from the coin-roll management apparatus 20 has been carried out without any problem. Thus, in this case, there is no need for controlling each register unit 10 and/or coin-roll management apparatus 20 to perform any additional operation.

Meanwhile, if the decreased amount of money of the one or more coin rolls decreased in the coin-roll management apparatus 20 is not coincident with the amount of money of the coins refilled to the coin change machine 14 of each register unit 10, a message, e.g., “ERROR” or the like, is displayed on the display panel 21a of the coin-roll management apparatus 20, thereby to provide an alert concerning this problem to the user and/or manager of the change refill and management system. However, such an alerting unit for alerting user and/or manager this problem is not limited to the display of the problem on the display panel 21a of the coin-roll management apparatus 20, but may include any other suitable variations that can be achieved, such as by providing the alert to the user and/or manager, by utilizing light, sound or the like, on the side of the coin-roll management apparatus 20, or by providing the alert to the user and/or manager, by utilizing the light, sound, display or the like, on the side of each register unit 10. Alternatively, this alerting unit may be configured to send the alert to a portable terminal or the like of the manager of the change refill and management system.

Next, referring to the flow chart of FIG. 11, the operation of the change refill and management system constructed as described above will be discussed.

If the coin change machine 14 of a certain register unit 10, among the plurality of register units 10, is short of the coins of a particular denomination, a signal indicating that the coins for the change stored in the certain coin change machine 14 are running short (hereinafter, this signal will be referred to as the “change-coin-shortage signal”) is sent, from the control unit 14a of this coin change machine 14, to the control unit 22 of the coin-roll management apparatus 20 (Step 1). Once such a change-coin-shortage signal is sent to the control unit 22, the control unit 22 releases the lock on each coin-roll drawer 23, 24, 25 of the coin-roll management apparatus 20 (Step 2). Thus, the user can draw out each coin-roll drawer 23, 24, 25 from the casing 21 and take out one or more of necessary coin rolls from each coin-roll drawer 23, 24, 25 drawn out, thereby refilling the certain coin change machine 14 with the loose coins that can be obtained by unwrapping the package of each coin roll taken out (Step 3). Thereafter, when each coin-roll drawer 23, 24, 25 is returned into the casing 21, this coin-roll drawer 23, 24 or 25 is locked again (Step 4).

During this operation, the coin-roll-total-amount detection unit 22a of the coin-roll management apparatus 20 detects the respective total amounts of money of the coin-rolls in each coin-roll drawer 23, 24, 25, before and after the one or more coin rolls are taken out therefrom. In this way, the information on the decreased amount of money of the one or more coin rolls decreased in the coin-roll management apparatus 20 is sent to the control unit 22 (Step 5). Meanwhile, the refill information on the loose coins refilled to the coin change machine 14 of the certain register unit 10 is detected by the recognition unit 14c, and then this refill information on the loose coins is sent to the control unit 22 via the control unit 14a (Step 6).

In this manner, once the information on the total amount of money of the coin rolls detected by the coin-roll-total-amount detection unit 22a and the refill information on the coins detected by the recognition unit 14c are respectively sent to the control unit 22, this control unit 22 compares the decreased amount of money of the one or more coin rolls decreased in the coin-roll management apparatus 20 with the amount of money of the coins refilled to the coin change machine 14 of each register unit 10 (Step 7). As a result, if both of the amounts of money are the same relative to each other, the control unit 22 judges that the refill to the coin change machine 14 of the register unit 10, with the loose coins prepared from the one or more coin rolls taken out from the coin-roll management apparatus 20, has been appropriately carried out in the change refill and management system (Step 8). In this case, there is no need for controlling the register unit 10 and/or coin-roll management apparatus 20 to perform any additional operation. Meanwhile, if both of the total amounts of money are not coincident with each other, the controller 22 judges that some problem has occurred in the refill to the coin change machine 14 of the register unit 10 with the loose coins prepared from the one or more coin rolls taken out from the coin-roll management apparatus 20. Then, the message, e.g., “ERROR” or the like, is displayed on the display panel 21a of the coin-roll management apparatus 20, thus providing the alert on this problem to the user and/or manager of the change and refill management system (Step 9). Please note that, as described above, this alerting unit for providing the alert to the user and/or manager, when the decreased amount of money of the one or more coin rolls decreased in the coin-roll management apparatus 20 is not coincident with the amount of money of the coins refilled to the coin change machine 14 of each register unit 10, is not limited to the display of that problem on the display panel 21a of the coin-roll management apparatus 20, but may include any other suitable variations that can be achieved, such as by providing the alert to the user and/or manager, by utilizing the light, sound, display or the like, on the side of the register unit 10 or the coin-roll management apparatus 20, or otherwise by providing the alert to the portable terminal or the like of the manager of the change refill and management system.

As described above, according to the change refill and management system of this embodiment, more than one register unit 10 is provided to the one coin-roll management apparatus 20, while each register unit 10 is connected, for communication, with the coin-roll management apparatus 20. In this manner, since more than one register unit 10 can be provided to the one coin-roll management apparatus 20, there is no need for installing the plurality of coin-roll management apparatuses 20, the number of which corresponds to the number of such a plurality of register units 10, thus substantially reducing the initial cost for the coin-roll management apparatus 20. Further, since the coins for the change can be refilled from the one coin-roll management apparatus 20 to the plurality of register units 10, the total amount of the coin-rolls stored in the coin-roll management apparatus 20 can be significantly reduced, as compared with the case in which the coin-roll management apparatuses 20 are provided with the register units 10, one by one. This is because, if the coin-roll management apparatuses 20 are provided with the register units 10, one by one, it is necessary for each coin-roll management apparatus 20 to store some excessive amount of the coin rolls therein, thus leading to an unduly large total amount of the coin rolls respectively stored in such coin-roll management apparatuses 20. Meanwhile, in this embodiment, the one coin-roll management apparatus 20 can be used commonly for the plurality of register units 10. Thus, even in the case the change of a certain denomination or denominations is dispensed, in a relatively great amount, from some register units 10 among the plurality of register units 10, the negative effects that may be caused by the lack of balance of the denominations of the change dispensed can be prevented.

It should be understood that the change refill and management system of this invention is not limited to such an aspect as described above, but various modifications and/or alterations may be made thereto.

For instance, each register unit 10 is not limited to the register unit including the cash register 12 and coin change machine 14, but may include the cash register 12 and drawer (not shown). In this alteration, the control unit is not provided to the drawer, while the control unit 12a of the cash register 12 is connected, for communication, with the control unit 22 of the coin-roll management apparatus 20. With this configuration, once the amount of money of the loose coins refilled into the drawer is inputted, by hand, to the cash register 12 by the user, this coin-refill-information inputted, by hand, to the cash register 12 and the information concerning the total amount of money of the coin-rolls in the coin-roll management apparatus 20 detected by the coin-roll-total-amount detection unit 22a, are respectively sent to the control unit 12a or control unit 22. Then, in the control unit 12a or control unit 22, the decreased amount of money of the one or more coin rolls decreased in the coin-roll management apparatus 20 is compared with the amount of money of the coins refilled into the drawer of each register unit 10.

As still another example of each register unit 10, one register unit including the cash register 12 and a banknote change machine and the coin change machine 14, or another register unit including the cash register 12, the drawer and the coin change machine 14, or the like can be utilized. Namely, each register unit 10 can be provided in various forms not limited to the aspect as described above, provided that this register unit includes at least the change machine or the drawer.

Further, the number of the register units 10 provided in the change refill and management system is not limited to two. For instance, three or more register units 10 may be provided to the one coin-roll management apparatus 20.

In addition, the number of the coin-roll management apparatuses 20 provided to the change refill and management system is not limited to one. For instance, as shown in FIG. 2, two coin-roll management apparatuses 20 and three register units 10 may be respectively provided in the change refill and management system. In this case, the control unit 22 of each respective coin-roll management apparatus 20 is connected, for communication, with the control unit 14a of each respective coin change machine 14. Also in this case, for each coin-roll management apparatus 20, the plurality of register units 10 are connected, for communication, with the one coin-roll management apparatus 20, and then the number of such coin-roll management apparatuses 20 can be substantially lessened relative to the number of the register units 10, as compared with the case in which the coin-roll management apparatuses 20 are provided with the register units 10, one by one. Therefore, the initial cost for such coin-roll management apparatus 20 can be significantly reduced. Of course, three or more coin-roll management apparatuses 20 and the plurality of (preferably, four or more) register units 10 may be respectively provided, while such a plurality of register units 10 are respectively connected, for communication, with each of the coin-roll management apparatuses 20.

Further, the change refill and management system of this invention may be a POS system (or point-of-sale system). In this case, as shown in FIG. 3, each register unit 10 and the coin-roll management apparatus 20 are located in a sales area 40, while a POS system unit 30 of the POS system is located outside the sales area 40. This POS system unit 30 includes a control unit 32, such as a host computer or the like. The cash register 12 of each register unit 10 is provided as a POS register, and the control unit 12a of each cash register 12 is connected, for communication, with the control unit 32 of the POS system unit 30 located outside the sales area 40. Further, in this case, as shown in FIG. 3, the coin-roll management apparatus 20 is not directly connected, for communication, with the plurality of register units 10, but is directly connected, for communication, with only one register unit 10, among the plurality of register units 10. However, this coin-roll management apparatus 20 is connected, indirectly, for communication, with the other register units 10, via the only one register unit 10 directly connected, for communication, therewith and/or the POS system unit 30. In addition, an alarming unit 50 is provided in the sales area 40, while being connected, for communication, with the control unit 32 of the POS system unit 30.

In the change refill and management system (i.e., the POS system) as shown in FIG. 3, once the signal indicating the shortage of the coins for the change stored in the coin change machine 14 of the certain register unit 10 is sent to the control unit 32 of the POS system unit 30, via the control unit 12a, from the control unit 14a of this coin change machine 14, the control unit 32 sends an instruction to the control unit 22 of the coin-roll management apparatus 20, in order to release the lock on each coin-roll drawer 23, 24, 25 of the coin-roll management apparatus 20. Thus, the user can draw out each coin-roll drawer 23, 24, 25 from the casing 21, take out one or more of necessary coin rolls from the drawer 23, 24 or 25, and then unwrap the package of each coin roll taken out, so as to prepare the loose coins, thereby refilling the coin change machine 14 with the so-prepared loose coins.

In this case, when the refill to the coin change machine 14 with the loose coins prepared by unwrapping each coin roll taken out from the coin-roll management apparatus 20 is performed, the information concerning the total amount of money of the coin rolls, detected by the coin-roll-total-amount detection unit 22a of the coin-roll management apparatus 20, is sent to the control unit 32 of the POS system unit 30, via the control unit 14a and control unit 12a, from the control unit 22. Meanwhile, the refill information concerning the loose coins refilled to the coin change machine 14, detected by the recognition unit 14c of the register unit 10, is also sent to the control unit 32 of the POS system unit 30, via the control unit 12a.

In this way, once the information on the total amount of money of the coin rolls detected by the coin-roll-total-amount detection unit 22a and the refill information on the coins detected by the recognition unit 14c are respectively sent to the control unit 32 of the POS system unit 30, this control unit 32 compares the decreased amount of money of the one or more coin rolls decreased in the coin-roll management apparatus 20 with the amount of money of the coins refilled to the coin change machine 14 of the register unit 10. Then, if both the amounts of money are the same relative to each other, the control unit 32 judges that the refill to the coin change machine 14 of the register unit 10, with the loose coins prepared from the one or more coin rolls taken out from the coin-roll management apparatus 20, has been appropriately carried out in the change refill and management system. In this case, there is no need for controlling each register unit 10 and/or coin-roll management apparatus 20 to perform any additional operation. Meanwhile, if both the total amounts of money are not coincident with each other, the controller 32 judges that some problem has occurred in the refill to the coin change machine 14 of the register unit 10, with the loose coins prepared from the one or more coin rolls taken out from the coin-roll management apparatus 20, and then sends an alarm signal to the alarming unit 50. Once the alarm signal is received, the alarming unit 50 provides the alert to the user or manager, by, for example, utilizing the light, sound, display or the like.

In another example of the POS system including the POS system unit 30, as shown in FIG. 4, the control unit 22 of the coin-roll management apparatus 20 may be directly connected, for communication, with the control unit 32 of the POS system unit 30. Also in this case, the information concerning the total amount of money of the coin rolls detected by the coin-roll-total-amount detection unit 22a of the coin-roll management apparatus 20 and the refill information concerning the coins detected by the recognition unit 14c of each register unit 10 are respectively sent to the control unit 32 of the POS system unit 30. Then, the control unit 32 compares the decreased amount of money of the one or more coin rolls decreased in the coin-roll management apparatus 20 with the amount of money of the coins refilled to the coin change machine 14 of each register unit 10.

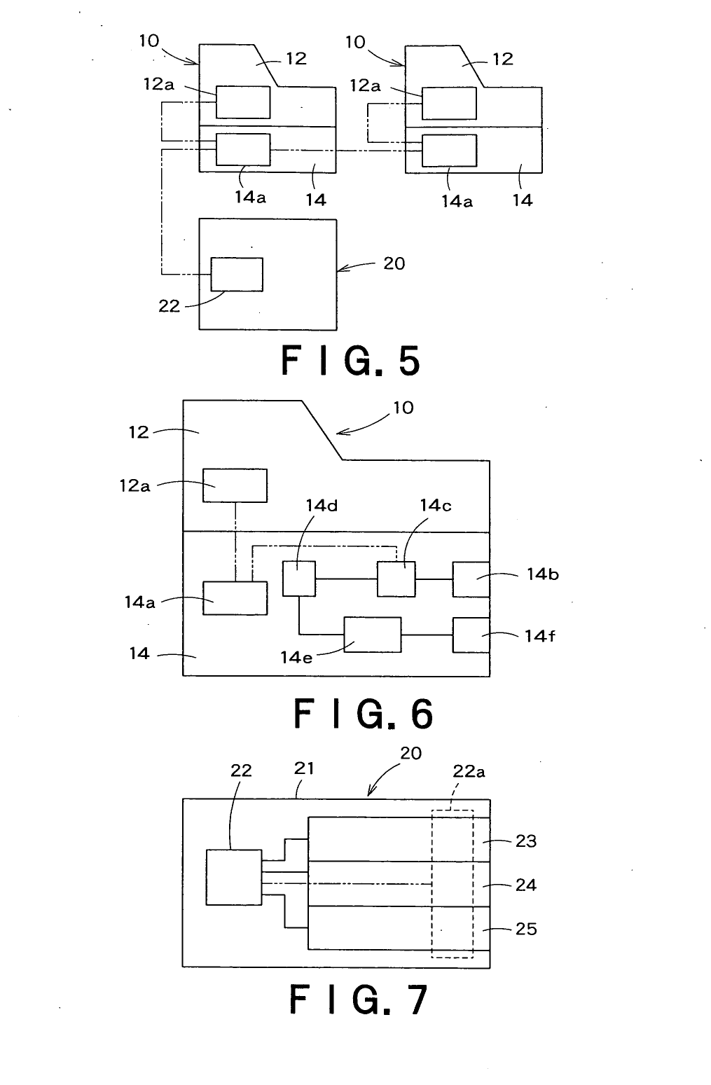

Alternatively, rather than connecting all of the plurality of register units 10, directly, for communication, with the coin-roll management apparatus 20, as shown in FIG. 1, the coin-roll management apparatus 20 may be directly connected, for communication, with one register unit 10 among the plurality of register units 10, while such a plurality of register units 10 are connected, for communication, with one another, as shown in FIG. 5. In this case, the coin-roll management apparatus 20 is connected, indirectly, for communication, with the other register units 10, via one of the register units 10 directly connected, for communication, with the coin-roll management apparatus 20. Also in the case of such a change refill and management system as shown in FIG. 5, the information concerning the total amount of money of the coin rolls detected by the coin-roll-total-amount detection unit 22a and the refill information concerning the coins detected by the recognition unit 14c are respectively sent to any of the control unit 12a, control unit 14a and control unit 22. Then, the control unit that receives such information compares the decreased amount of money of the one or more coin rolls decreased in the coin-roll management apparatus 20 with the amount of money of the coins refilled to the coin change machine 14 of each register unit 10.

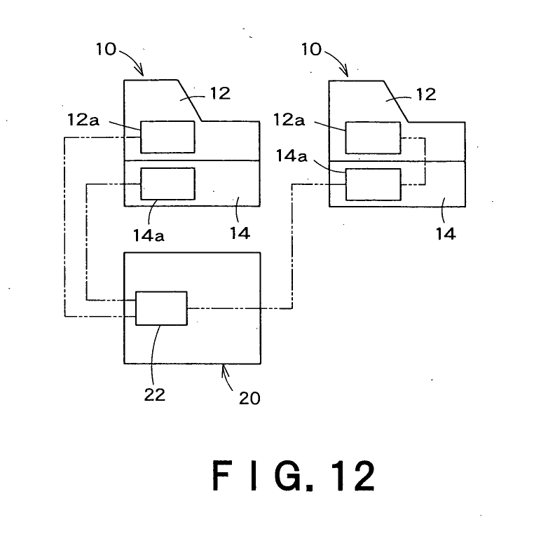

In still another variation, the register unit 10 can be newly introduced, in addition to the register unit 10 and coin-roll management apparatus 20 already provided. It will be described below in the case the control unit 12a of the cash register 12 of the register unit 10 already provided is not be connected with the control unit 14a of the coin change machine thereof, while such control units 12a, 14a may be respectively connected with the control unit 22 of the coin-roll management apparatus 20. For instance, as shown in FIG. 12, the register unit 10 located on the left side, among two register units 10 respectively depicted in this drawing, and the coin-roll management apparatus 20 are already provided, while the right side register unit 10 in the same drawing is newly introduced, and the control unit 12a of the cash register 12 and the control unit 14a of the coin change machine 14, respectively provided in the newly-increased register unit 10, are connected relative to each other. In this example, the control unit 14a of the coin change machine 14 of this newly-increased register unit 10 is connected with the control unit 22 of the coin-roll management apparatus 20.

Alternatively, if the control unit 12a of the cash register 12 and the control unit 14a of the coin change machine 14 of such a newly-increased register unit 10 are not connected with each other, such control units 12a, 14a may be connected with the control unit 22 of the coin-roll management machine 20, respectively.

In yet still another variation, if the information concerning the total amount of money of the coin rolls detected by the coin-roll-total-amount detection unit 22a and the refill information concerning the coins detected by the recognition unit 14c are respectively sent to the control unit 22 of the coin-roll management apparatus 20, in any one of the change refill and management systems as respectively shown in FIGS. 1 through 5, the refill of the coins, from the coin-roll management apparatus 20, to the certain register unit 10 among the plurality of register units 10 may be performed, while the signal indicative of the shortage of the coins for the change sent from any other register units 10 is rejected by the control unit 20.

More specifically, once the signal indicative of the shortage of the coins for the change is sent from the certain register unit 10 to the control unit 22, the control unit 22 releases the lock on each coin-roll drawer 23, 24, 25 of the coin-roll management apparatus 20. Thus, the user can draw out each coin-roll drawer 23, 24, 25, and take out the one or more coin rolls from such a coin-roll drawer 23, 24 or 25 drawn out. Thereafter, when the user returns each coin-roll drawer 23, 24, 25 into the casing 21 of the coin-roll management apparatus 20, the coin-roll drawer 23, 24 or 25 is locked again. In this case, once the control unit 22 receives the signal indicating the shortage of the coins for the change sent from the certain register unit 10, this control unit 22 releases the lock on each coin-roll drawer 23, 24, 25, while rejecting the signal indicating the shortage of the coins for the change sent from any other register units 10. Thereafter, once each coin-roll drawer 23, 24, 25 is returned into the casing 21 and the coin-roll-total-amount detection unit 22a detects that the one or more coin rolls are taken out from the coin-roll drawer 23, 24 or 25, the control unit 22 receives the signal indicating the shortage of the coins for the change sent from the other register units 10.

This configuration of the control unit 22 can successfully prevent the user from mistaking the coins to be refilled to the certain register unit 10 for the coins to be refilled to any other register units 10, when several register units 10 are short of the coins at the same time. In other words, this configuration can effectively prevent the user from mistakenly refilling the coins taken out from the coin-roll management apparatus 20, to a register unit 10 other than the register unit 10 to be refilled with such coins. In particular, this solution for preventing the user from mistakenly refilling the coins is effective, if the system is operated by a plurality of users, while each user refills each register unit 10, in his or her charge, with the coins.

Further, in this case, if the coin rolls to be refilled to the certain register unit 10 are not taken out from each coin-roll drawer 23, 24, 25 of the coin-roll management apparatus 20 within a predetermined period of time, when the refill of the coins to the coin change machine 14 of this register unit 10 from the coin-roll management apparatus 20 has to be performed, the control unit 22 may cancel the refill of such coins to the certain register unit 10 from the coin-roll management apparatus 20. Specifically, after the signal concerning the shortage of the coins for the change is sent to the control unit 22 from the coin change machine 14 of the certain register unit 10 and thus the control unit 22 releases the lock on each coin-roll drawer 23; 24, 25 of the coin-roll management apparatus 20, if the coin-rolls are not taken out from each coin-roll drawer 23, 24, 25 within a predetermined period of time, the coin-roll drawer 23, 24 or 25 may be locked again.

In yet still another variation, the control unit 22 may conduct monitoring of each refill of the coins to several register units 10 from the coin-roll management apparatus 20. More specifically, once the signals respectively indicating the shortage of the coins for the change are sent to the control unit 22 from the coin change machines 14 of the several register units 10, the control unit 22 keeps the lock on each coin-roll drawer 23, 24, 25 of the coin-roll management apparatus 20 released and the user can refill, in parallel, the coin change machines 14 of the respective register units 10 with the coins. Thereafter, once all of the information on the refill of the coins to the coin change machines 14 of the several register units 10 are sent to the control unit 22, this control unit 22 compares the decreased amount of money of the one or more coin rolls decreased in the coin-roll management apparatus 20 with the amount of money of the coins refilled to the coin change machines 14 of the respective register units 10. In this way, the refill of the loose coins for the change to such a plurality of register units 10 can be performed at the same time.

1. A change refill and management system, comprising:
a coin-roll management apparatus capable of storing therein coin rolls of a plurality of denominations; and
a plurality of register units, each register unit including at least a change machine or drawer, more than one register unit being provided to the one coin-roll management apparatus in the vicinity of the coin-roll management apparatus,
wherein the coin-roll management apparatus includes a storage body, a coin-roll drawer provided to be optionally drawn out from the storage body and having a plurality of coin-roll storage units, each coin-roll storage unit being capable of storing therein one coin roll, and a coin-roll-total-amount detection unit for detecting the total amount of money of one or more coin rolls stored in the coin-roll drawer,
each of the register units includes a coin-refill-information detection unit for detecting refill information on the coins refilled to the change machine or drawer of the register unit, and
each of the register units is connected, for communication, with the coin-roll management apparatus.

2. The coin refill and management system according to claim 1
wherein a control unit is provided to at least one of the coin-roll management apparatus and each register unit,
the control unit serves to receive information concerning the total amount of money of the one or more coin rolls detected by the coin-roll-total-amount detection unit and the refill information on the coins detected by the coin-refill-information detection unit, and
the control unit compares the information concerning total amount of money of the one or more coin rolls in the coin-roll management apparatus with the refill information on the coins refilled to the change machine or drawer of each register unit.

3. The coin refill and management system according to claim 2,
wherein the control unit compares a decreased amount of money of the one or more coin rolls decreased in the coin-roll management apparatus with the amount of money of the coins refilled to the change machine or drawer of each of the register units, and if both of the amounts of money are the same relative to each other, the control unit judges that the refill of the coins to each of the register units from the coin-roll management apparatus has been carried out without any problem.

4. The coin refill and management system according to claim 2,
wherein the control unit compares a decreased amount of money of the one or more coin rolls decreased in the coin-roll management apparatus with the amount of money of the coins refilled to the change machine or drawer of each of the register units,
the coin refill and management system further comprises an alerting unit, and
when both of the amounts of money are not coincident with each other, the alerting unit alerts a user that both of the amounts of money are not coincident with each other.

5. The coin refill and management system according to claim 1
wherein each of the register units is directly connected, for communication, with the coin-roll management apparatus.

6. The coin refill and management system according to claim 1,
wherein the register units are connected, for communication, with one another, and the coin-roll management apparatus is connected, for communication, with at least one of the register units.

7. The coin refill and management system according to claim 1,
wherein the plurality of coin-roll management apparatuses are provided, and each of the register units is connected, for communication, with the plurality of coin-roll management apparatuses.

8. The coin refill and management system according to claim 2,
wherein while the refill of the coins to one register unit among the plurality of register units from the coin-roll management apparatus is performed, the control unit rejects receiving any signal sent from the other register units.

9. The coin refill and management system according to claim 8,
wherein once the coin-roll-total-amount detection unit detects that the one or more coin rolls to be refilled to the one register unit have been taken out from the coin-roll drawer in the coin-roll management apparatus, the control unit is capable of receiving a signal sent from the other register units.

10. The coin refill and management system according to claim 8,
wherein if the one or more coin rolls to be refilled to the one register unit are not taken out from the coin-roll drawer within a predetermined period of time, when the refill of the coins to the one register unit among the plurality of register units from the coin-roll management apparatus has to be performed, the control unit cancels the refill of the coins to the one register unit from the coin-roll management apparatus.

11. The coin refill and management system according to claim 2,
wherein the control unit conducts monitoring of each refill of the coins to the plurality of register units from the coin-roll management apparatus.

12. The coin refill and management system according to claim 1,
wherein the coin refill and management system further comprises a POS system unit connected, for communication, with the coin-roll management apparatus, and connected, for communication, with each of the register units, the POS system unit including a control unit,
the control unit serves to receive information concerning the total amount of money of the one or more coin rolls detected by the coin-roll-total-amount detection unit and the refill information on the coins detected by the coin-refill-information detection unit, and
the control unit compares the information concerning the total amount of money of the one or more coin rolls in the coin-roll management apparatus with the refill information on the coins refilled to the change machine or drawer of each of the register units.

13. The coin refill and management system according to claim 12,
wherein the control unit compares a decreased amount of money of the one or more coin rolls decreased in the coin-roll management apparatus with the amount of money of the coins refilled to the change machine or drawer of each of the register units, and if both of the amounts of money are the same relative to each other, this control unit judges that the refill of the coins to each of the register units from the coin-roll management apparatus has been carried out without any problem.

14. The coin refill and management system according to claim 12,
wherein the control unit compares a decreased amount of money of the one or more coin rolls decreased in the coin-roll management apparatus with the amount of money of the coins refilled to the change machine or drawer of each of the register units, and
the coin refill and management system further comprises an alerting unit, and
when both of the amounts of money are not coincident with each other, the alerting unit alerts a user that both of the amounts of money are not coincident with each other.

15. The coin refill and management system according to claim 12,
wherein while the refill of the coins to one register unit among the plurality of register units from the coin-roll management apparatus is performed, the control unit rejects receiving any signal sent from the other register units.
